(19) United States
(12) Patent Application Publication
(10) Pub. No.: US 2025/0015290 A1
(43) Pub. Date: Jan. 9, 2025

(54) ALL-SOLID-STATE BATTERY HAVING ANODE LAYER INCLUDING METAL-ORGANIC FRAMEWORK

(71) Applicants: Hyundai Motor Company, Seoul (KR); Kia Corporation, Seoul (KR); UIF (University Industry Foundation), Yonsei University, Seoul (KR)

(72) Inventors: Ki Yoon Bae, Seoul (KR); Sam Ick Son, Suwon (KR); Ji Young Kim, Suwon (KR); Jong Hyeok Park, Seoul (KR); Min Je Ryu, Seoul (KR)

(21) Appl. No.: 18/530,099

(22) Filed: Dec. 5, 2023

(30) Foreign Application Priority Data
Jul. 6, 2023 (KR) 10-2023-0087755

(51) Int. Cl. H01M 4/60; H01M 10/0562

(52) U.S. Cl. CPC H01M 4/608; H01M 10/0562; H01M 2004/027; H01M 10/052; H01M 2220/20

(57) ABSTRACT

The present disclosure relates to an all-solid-state battery having an anode layer including a solid electrolyte metal-organic framework; a solid electrolyte layer disposed on the anode layer; and a cathode layer disposed on the solid electrolyte layer. The all-solid-state battery may further include a lithium layer interposed between the anode layer and the solid electrolyte layer.

### CROSS-REFERENCE TO RELATED APPLICATION

This application claims under 35 U.S.C. § 119 (a) the benefit of priority to Korean Patent Application No. 10-2023-0087755 filed on Jul. 6, 2023, the entire contents of which are incorporated herein by reference.

### BACKGROUND

### (a) Technical Field

The present disclosure relates to an all-solid-state battery having an anode layer including a metal-organic framework.

### (b) Background Art

Nowadays, secondary batteries are widely used from automobiles, large devices such as power storage systems, etc. to small devices such as mobile phones, camcorders, laptop computers, etc.

As the fields of application of secondary batteries are widening, there is an increasing demand for improved safety and higher performance of batteries.

A lithium secondary battery, which is one of the secondary batteries, has advantages in that it has a high energy density and a large capacity per unit area compared to a nickel-manganese battery or a nickel-cadmium battery.

However, most electrolytes used in conventional lithium secondary batteries are liquid electrolytes such as organic solvents and the like. Therefore, safety issues such as leakage of electrolyte and the risk of fire due thereto have been constantly raised.

Accordingly, interest in an all-solid-state battery using a solid electrolyte rather than a liquid electrolyte as an electrolyte used in order to increase the safety of a lithium secondary battery has recently increased.

### SUMMARY

We now provide an all-solid-state battery comprising an electrode layer that comprises a metal-organic framework (MOF).

In particular embodiments, an all-solid-state battery is provided that comprises an anode layer comprises a metal-organic framework (MOF). Suitably, the anode layer comprises a slid electrolyte and the metal-organic framework (MOF).

In one aspect, an all-solid-state battery according may include: 1) an anode current collector; 2) an anode layer disposed on the anode current collector; 3) a solid electrolyte layer disposed on the anode layer; 4) optionally, a cathode layer disposed on the solid electrolyte layer; and 5) optionally, a cathode current collector disposed on the cathode layer, wherein the anode layer may include a solid electrolyte and a metal-organic framework (MOF).

The solid electrolyte layer may include a sulfide-based solid electrolyte.

In certain embodiments, the solid electrolyte of a battery may include a sulfide-based solid electrolyte. The solid electrolyte layer may include a sulfide-based solid electrolyte. The solid electrolyte may be the same as a solid electrolyte of the solid electrolyte layer.

The terms “metal organic framework” and “MOF” are used herein in accordance with their ordinary meaning and refer to a composition including metal atoms coordinated to organic ligands (e.g., metal organic framework linkers). In one aspect, metal organic frameworks can be designated as periodic coordinated networks of metal nodes connected via ligands Organic ligands (e.g., metal organic framework linkers), metal ion nodes, and optionally additional ions (e.g., O²⁻), may be referred to collectively as secondary building units (SBUs). In embodiments, the SBU includes the metal and the metal organic framework linkers. In embodiments, the SBU includes the metal ion node. In embodiments, a metal organic framework includes one or a plurality of metal organic framework linkers, the linkers being the same or different.

The term “metal organic framework linker” or “ligand” is used in accordance with its ordinary meaning in chemistry and MOF chemistry and refers to the organic ligand capable of connecting a metal (e.g., metal atom, metal ion nodes within SBUs, metal ion nodes) in a MOF via metal binding ligand moieties or metal binding atom. In embodiments, the metal organic framework linker is covalently connected (e.g., directly or indirectly) to a different metal organic framework linker. In embodiments, a first metal organic framework linker is covalently connected to a second metal organic framework linker via a covalent linker moiety (e.g., a polymer). In embodiments, a first metal organic framework linker is covalently connected to a second identical metal organic framework linker. In embodiments, a metal organic framework linker is divalent. In embodiments, a metal organic framework linker is substituted terephthalic acid. In embodiments, a metal organic framework linker includes ditopic or polytopic metal binding ligand moieties. Metal organic framework linkers have been reported in U.S. Pat. No. 7,196,210.

In embodiments, the metal-organic framework may include: metal ions; and organic ligands bonded to the metal ions.

In embodiments, the metal ions may include ions of at least one metal selected from the group consisting of lithium (Li), manganese (Mn), nickel (Ni), cobalt (Co), and combinations thereof.

In embodiments, the organic ligands may include at least one selected from the group consisting of 1,4-benzenedicarboxylic acid (1,4-BDCA), 2,6-naphthalenedicarboxylic acid (2,6-NDCA), ellagic acid (EA), 1,4,5,8-naphthalenetetracarboxylic acid (1,4,5,8-NTCA), 3,4,9,10-perylenetetracarboxylic acid (3,4,9,10-PTCA), biphenyltetracarboxylic acid (BPTC), 2,5-thiophenedicarboxylic acid (2,5-TPDC), and combinations thereof.

In particular aspect, the organic ligand may comprise 2,5-thiophenedicarboxylic acid (2,5-TPDC), which has shown to provide notable results. See the examples which follow.

In certain embodiments, the anode layer may include from about 30% by weight to about 55% by weight of the solid electrolyte and about 45% by weight to about 70% by weight of the metal-organic framework. The anode layer may include more than about 55% by weight of the solid electrolyte and less than about 45% by weight of the MOF.

In certain systems, an all-solid-state battery may further include a lithium layer interposed between the anode layer and the solid electrolyte layer.

In certain systems, the lithium layer may include lithium powder.

According to the present disclosure, an all-solid-state battery having an anode layer including a metal-organic framework can be obtained.

According to the present disclosure, an all-solid-state battery with improved initial coulombic efficiency can be obtained.

According to the present disclosure, an all-solid-state battery with improved capacity retention rate can be obtained.

In some embodiments, an all-solid-state battery includes an anode layer including a solid electrolyte and a metal-organic framework (MOF); a lithium layer disposed on the anode layer; a solid electrolyte layer disposed on the lithium layer; and a cathode layer disposed on the solid electrolyte layer.

In some embodiments, an all-solid-state battery includes an anode layer including cobalt as a solid electrolyte and 2,5-thiophenedicarboxylic (2,5-TPDC) as a metal-organic framework (MOF); a lithium layer disposed on the anode layer; a solid electrolyte layer disposed on the lithium layer; and a cathode layer disposed on the solid electrolyte layer.

Also provided is a vehicle including the all-solid-state battery as described herein.

A term “all-solid-state battery” as used herein includes or refers to a rechargeable battery (including a secondary battery) that includes an electrolyte in a solid state, e.g., gel or polymer (cured), which may include an ionomer and other electrolytic components for transferring ions between the electrodes of the battery.

Other embodiments of the invention are disclosed infra.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 shows a first embodiment of an all-solid-state battery according to the present disclosure.

FIG. 2 shows a second embodiment of an all-solid-state battery according to the present disclosure.

FIG. 3 shows charge/discharge capacity and coulombic efficiency of an all-solid-state battery according to Example 1.

FIG. 4 shows charge/discharge capacity and coulombic efficiency of an all-solid-state battery according to Example 2.

FIG. 5 shows charge/discharge capacity and coulombic efficiency of an all-solid-state battery according to Example 3.

FIG. 6 shows charge/discharge capacity and coulombic efficiency of an all-solid-state battery according to Example 4.

FIG. 7 shows specific capacity according to charging and discharging of the all-solid-state battery according to Example 1.

FIG. 8 shows specific capacity according to charging and discharging of the all-solid-state battery according to Example 2.

FIG. 9 shows specific capacity according to charging and discharging of the all-solid-state battery according to Example 3.

FIG. 10 shows specific capacity according to charging and discharging of the all-solid-state battery according to Example 4.

FIG. 11 shows a capacity retention rate of the all-solid-state battery according to Example 1.

FIG. 12 shows a capacity retention rate of the all-solid-state battery according to Example 2.

FIG. 13 shows a capacity retention rate of the all-solid-state battery according to Example 3.

FIG. 14 shows a capacity retention rate of the all-solid-state battery according to Example 4.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, dimensions of the structures are shown enlarged than actual for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part, but also the case where there is another part in the middle therebetween. Conversely, when a part of a layer, film, region, plate, etc. is said to be “under” other part, this includes not only the case where it is “directly under” the other part, but also the case where there is another part in the middle therebetween.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous, and includes all values from a minimum value of such a range to the maximum value including a maximum value, unless otherwise indicated. Furthermore, when such a range refers to an integer, all integers including from the minimum value to the maximum value including a maximum value are included, unless otherwise indicated. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred embodiments, a vehicle may be electric-powered, including a hybrid vehicles, plug-in hybrids, or vehicles where electric power is the primary or sole power source.

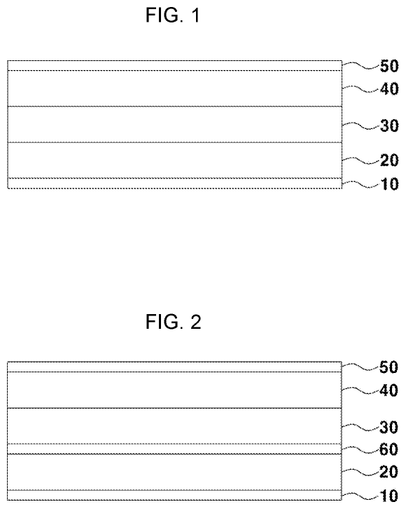

FIG. 1 shows a first embodiment of an all-solid-state battery according to the present disclosure. The all-solid-state battery may include an anode current collector 10, an anode layer 20 disposed on the anode current collector 10, a solid electrolyte layer 30 disposed on the anode layer 20, a cathode layer 40 disposed on the solid electrolyte layer 30, and a cathode current collector 50 disposed on the cathode layer 40.

The anode current collector 10 may be a plate-shaped substrate having electrical conductivity. Specifically, the anode current collector 10 may have a sheet, thin film or foil form.

The anode current collector 10 may include a material that does not react with lithium. Specifically, in certain embodiments, the anode current collector 10 may include at least one selected from the group consisting of nickel (Ni), copper (Cu), stainless steel, and combinations thereof.

The anode layer 20 suitably may include a solid electrolyte and a metal-organic framework (MOF).

The solid electrolyte suitably may conduct lithium ions in the anode layer 20, or other materials.

In certain preferred embodiments, the solid electrolyte may include at least one selected from the group consisting of an oxide-based solid electrolyte, a sulfide-based solid electrolyte, a polymer electrolyte, and combinations thereof. Preferably, the solid electrolyte may include a sulfide-based solid electrolyte.

In certain preferred embodiments, a sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂—LiₓMO_{y} (provided that x and y are positive numbers, and M is one of P, Si, Ge, B, Al, Ga, and In), Li₁₀GeP₂S₁₂, and the like.

In certain preferred embodiments, an oxide-based solid electrolyte may include perovskite-type Li₃ₓLa_{2/3-x}TiO₃ (LLTO), phosphate-based NASICON-type Li₁₊ₓAlₓTi₂₋ₓ(PO₄)₃ (LATP), and the like.

In certain preferred embodiments, a polymer electrolyte may include a gel polymer electrolyte, a solid polymer electrolyte, and the like.

As discussed, the metal-organic framework (MOF) may include metal ions and organic ligands bonded to the metal ions. The metal ions and the organic ligands may be coordinately bonded or covalently bonded.

In preferred embodiments, a metal-organic framework (MOF) may have micropores and mesopores, which can effectively suppress the volume expansion of the anode layer 20 due to the charging product. In addition, since the combination of metal ions and organic ligands in the metal-organic framework (MOF) is diverse, using organic ligands containing a functional group having lithium ion conductivity may contribute to increasing the lithium ion conductivity in the anode layer 20.

In certain preferred embodiments, metal ions of a metal-organic framework may include ions of at least one metal selected from the group consisting of lithium (Li), manganese (Mn), nickel (Ni), cobalt (Co), and combinations thereof.

In certain preferred embodiments, organic ligands of a metal-organic framework may include at least one selected from the group consisting of 1,4-benzenedicarboxylic acid (1,4-BDCA), 2,6-naphthalenedicarboxylic acid (2,6-NDCA), ellagic acid (EA), 1,4,5,8-naphthalenetetracarboxylic acid (1,4,5,8-NTCA), 3,4,9,10-perylenetetracarboxylic acid (3,4,9,10-PTCA), biphenyltetracarboxylic acid (BPTC), 2,5-thiophenedicarboxylic acid (2,5-TPDC), and combinations thereof.

In certain preferred embodiments, a metal-organic framework (MOF) may have an average particle diameter (D50) of nanometers. For example, the metal-organic framework (MOF) may have an average particle diameter (D50) of about 1 nm to 500 nm. Since general metal-organic frameworks (MOFs) have a micrometer size, their electronic conductivity is somewhat lowered so that it has been difficult to use them for electrochemical purposes. However, the present disclosure has prevented electronic conductivity in the anode layer 20 from being reduced by using a nanometer-sized metal-organic framework (MOF).

A method for preparing the metal-organic framework (MOF) is not particularly limited. For example, the metal-organic framework (MOF) may be prepared by a hydrothermal synthesis method, an ultrasonic synthesis method, or the like, and preferably an ultrasonic synthesis method.

A non-limiting method for preparing the metal-organic framework (MOF) may include the steps of preparing a starting material including a solvent, a precursor of metal ions, and organic ligands, and irradiating the starting material with ultrasonic waves of a predetermined intensity for a predetermined time.

The solvent is not particularly limited, and may include at least one selected from the group consisting of N,N-dimethylformamide, distilled water, methanol, ethanol, propanol, dimethylacetamide, acetone, dimethylsulfoxide, N-methyl-2-pyrrolidone, and combinations thereof.

The precursor of metal ions may include a hydrate of the metal ions, a nitrate of the metal ions, an acetate of the metal ions, and the like.

The starting material may further include a catalyst that promotes a reaction between the precursor of metal ions and the organic ligands. The catalyst is not particularly limited, and may include, for example, triethylamine and the like.

The ultrasonic wave intensity and the irradiation time are not particularly limited, and may be appropriately adjusted in order to provide energy to the extent in which the metal ions' precursor and the organic ligands can sufficiently react.

The preparation method may further include a step of washing and drying the metal-organic framework (MOF) synthesized by irradiating the ultrasonic waves.

In certain systems, the anode layer 20 may include about 30% by weight to about 50% by weight of the solid electrolyte and about 50% by weight to about 70% by weight of the metal-organic framework (MOF). If the solid electrolyte has a content of less than 30% by weight, the initial coulombic efficiency and capacity of the all-solid-state battery may be lowered. When the solid electrolyte has a content exceeding 50% by weight, the content of the metal-organic framework (MOF) is relatively low, and thus the all-solid-state battery may not drive normally.

The solid electrolyte layer 30 suitably may be interposed between the cathode layer 40 and the anode layer 20 and suitably may include a solid electrolyte having lithium ion conductivity.

The solid electrolyte suitably may include at least one selected from the group consisting of an oxide-based solid electrolyte, a sulfide-based solid electrolyte, a polymer electrolyte, and combinations thereof. The solid electrolyte of the solid electrolyte layer 30 may be the same as or different from the solid electrolyte of the anode layer 20.

The solid electrolyte layer 30 suitably may further include a binder. The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode layer 40 suitably may include a cathode active material, a solid electrolyte, a conductive material, a binder, and the like.

In certain systems, the cathode active material suitably may reversibly intercalate and deintercalate lithium ions (Li⁺). The cathode active material may include an oxide active material. In certain systems, the oxide active material may include a rock salt layer-type active material such as LiCoO₂, LiMnO₂, LiNiO₂, LiVO₂, Li₁₊ₓNi_{1/3}Co_{1/3}Mn_{1/3}O₂, or the like, a spinel-type active material such as LiMn₂O₄, Li(Ni_{0.5}Mn_{1.5})O₄, or the like, a reverse spinel-type active material such as LiNiVO₄, LiCoVO₄, or the like, an olivine-type active material such as LiFePO₄, LiMnPO₄, LiCoPO₄, LiNiPO₄, or the like, a silicon-containing active material such as Li₂FeSiO₄, Li₂MnSiO₄, or the like, a rock salt layer-type active material in which a part of the transition metal is substituted with a dissimilar metal, such as LiNi_{0.8}Co_{(0.2-x)}AlₓO₂ (0<x<0.2), a spinel-type active material in which a part of the transition metal is substituted with a dissimilar metal, such as Li₁₊ₓMn_{2-x-y}M_{y}O₄ (M is at least one of Al, Mg, Co, Fe, Ni, and Zn, and 0<x+y<2), or a lithium titanate such as Li₄Ti₅O₁₂ or the like.

The solid electrolyte suitably may include at least one selected from the group consisting of an oxide-based solid electrolyte, a sulfide-based solid electrolyte, a polymer electrolyte, and combinations thereof. The solid electrolyte of the cathode layer 40 may be the same as or different from that of the anode layer 20 and/or the solid electrolyte layer 30.

The conductive material suitably may include carbon black, conductive graphite, ethylene black, carbon fiber, graphene, and the like.

The binder suitably may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder of the cathode layer 40 may be the same as or different from that of the solid electrolyte layer 30.

The cathode current collector 50 suitably may be a plate-shaped substrate having electrical conductivity, although other configurations also may be employed. Specifically, the cathode current collector 50 may have a sheet or thin film form.

The cathode current collector 50 suitably may include for example at least one selected from the group consisting of indium, copper, magnesium, aluminum, stainless steel, iron, and combinations thereof.

FIG. 2 shows a second exemplary embodiment of an all-solid-state battery according to the present disclosure. The all-solid-state battery may be one in which a lithium layer 60 is interposed between the anode layer 20 and the solid electrolyte layer 30.

The lithium layer 60 suitably may increase reversibility of redox reactions occurring in the all-solid-state battery. Accordingly, the initial coulombic efficiency, capacity retention rate, and the like of the all-solid-state battery may be increased.

The lithium layer 60 suitably may include lithium powder. A method for manufacturing the lithium layer 60 will be described later.

A method for manufacturing the all-solid-state battery according to this embodiment and other embodiments is not particularly limited. For example, a method for manufacturing the all-solid-state battery may include the steps of: preparing a slurry including a solid electrolyte and a metal-organic framework (MOF); applying the slurry onto a substrate and drying it to form an anode layer; and sequentially stacking an anode current collector, the anode layer, a solid electrolyte layer, a cathode layer, and a cathode current collector.

Further, the manufacturing method suitably may further include a step of forming a lithium layer by applying a dispersion containing lithium powder onto the anode layer and drying it.

In one embodiment, the dispersion may be prepared by injecting lithium powder into a dispersion medium that does not react with the lithium powder. For example, the lithium powder may be injected into the dispersion medium so that the lithium powder has a concentration of about 2% by weight to about 5% by weight.

The dispersion medium is not particularly limited, and may include, for example, toluene, dimethylformamide, hexane, heptane, N-methyl-2-pyrrolidone, dimethylacetamide, and the like.

In one embodiment, the lithium layer may be prepared by depositing lithium powder without injecting into a dispersion medium.

Hereinafter, other forms of the present disclosure will be described in more detail through Examples. The following Examples are merely examples to aid understanding of the present disclosure, and the scope of the present disclosure is not limited thereto.

### Preparation Example—Preparation of Metal-Organic Framework (MOF)

A solvent obtained by mixing about 20 ml of N, N-dimethylformamide, about 20 ml of distilled water, and about 20 ml of methanol was prepared. The solvent was divided into halves and put in a first container and a second container.

About 4 mmol of CoCl₂·6H₂O, a precursor of metal ions, was injected into the first container.

About 4 mmol of 2,5-thiophenedicarboxylic acid (2,5-TPDC), an organic ligand, was injected into the second container. About 8 mmol of sodium hydroxide (NaOH) was injected into the second container together.

After slowly putting the solution contained in the second container into the first container, about 0.8 ml of triethylamine as a catalyst was put into the first container and stirred for about 5 minutes to 10 minutes to prepare a starting material.

After putting the thus prepared starting material in a reactor blocked from the outside, ultrasonic waves of about 30 KHz to 50 KHz were irradiated for about 6 hours to 8 hours to synthesize a metal-organic framework (MOF).

The metal-organic framework (MOF) was separated using a centrifugal separator. The metal-organic framework (MOF) was washed at least three times with ethanol and vacuum-dried at about 100° C. to 120° C. for about 12 hours to 18 hours.

### Example 1

A slurry containing about 70% by weight of the metal-organic framework (MOF) of the above Preparation Example and about 30% by weight of a sulfide-based solid electrolyte was applied onto an anode current collector and dried to form an anode layer.

A solid electrolyte layer was prepared by pressurizing a sulfide-based solid electrolyte powder at about 400 MPa to 500 MPa.

A solid electrolyte layer was placed on the anode layer and pressurized at about 350 MPa to 400 MPa to attach the anode layer and the solid electrolyte layer.

A half-cell was manufactured by attaching a lithium foil onto the solid electrolyte layer.

While applying a pressure of about 30 MPa to 40 MPa to the half-cell, a pressed cell kit for battery evaluation was assembled to evaluate the electrochemical properties of the half-cell.

### Example 2

A half-cell was manufactured in the same manner as in Example 1 above except that a slurry containing about 60% by weight of a metal-organic framework (MOF) and about 40% by weight of a sulfide-based solid electrolyte was used, and its electrochemical properties were evaluated.

### Example 3

A half-cell was manufactured in the same manner as in Example 1 above except that a slurry containing about 50% by weight of a metal-organic framework (MOF) and about 50% by weight of a sulfide-based solid electrolyte was used, and its electrochemical properties were evaluated.

### Example 4

A slurry containing about 70% by weight of the metal-organic framework (MOF) of Preparation Example and about 30% by weight of the sulfide-based solid electrolyte was applied onto the anode current collector and dried to form an anode layer.

### Example 5

A half-cell was manufactured in the same manner as in Example 1 above except that a slurry containing about 45% by weight of a metal-organic framework (MOF) and about 55% by weight of a sulfide-based solid electrolyte was used, and its electrochemical properties were evaluated.

A dispersion was prepared by injecting lithium powder into toluene as a dispersion medium in a glove box so that the dispersion had a concentration of about 3% by weight.

About 20 ml to 50 ml of the dispersion was dropped onto the anode layer. The resulting product was vacuum-dried at about 100° C. to 150° C. to form a lithium layer.

A solid electrolyte layer was prepared by pressurizing the sulfide-based solid electrolyte powder at about 400 MPa to 500 MPa.

The solid electrolyte layer was placed on the lithium layer and pressurized at about 350 MPa to 400 MPa to attach the lithium layer and the solid electrolyte layer.

A half-cell was manufactured by attaching a lithium foil onto the solid electrolyte layer.

While applying a pressure of about 30 MPa to 40 MPa to the half-cell, a pressed cell kit for battery evaluation was assembled to evaluate the electrochemical properties of the half-cell.

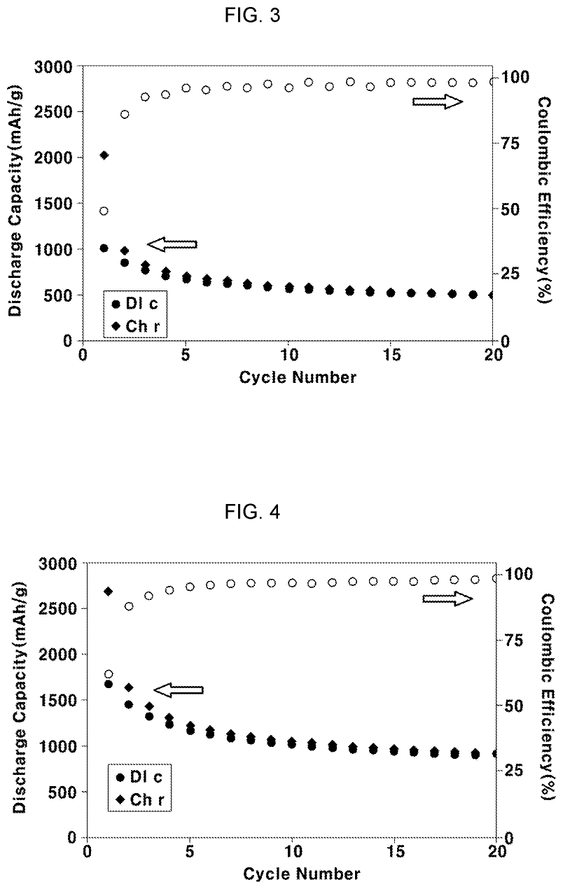

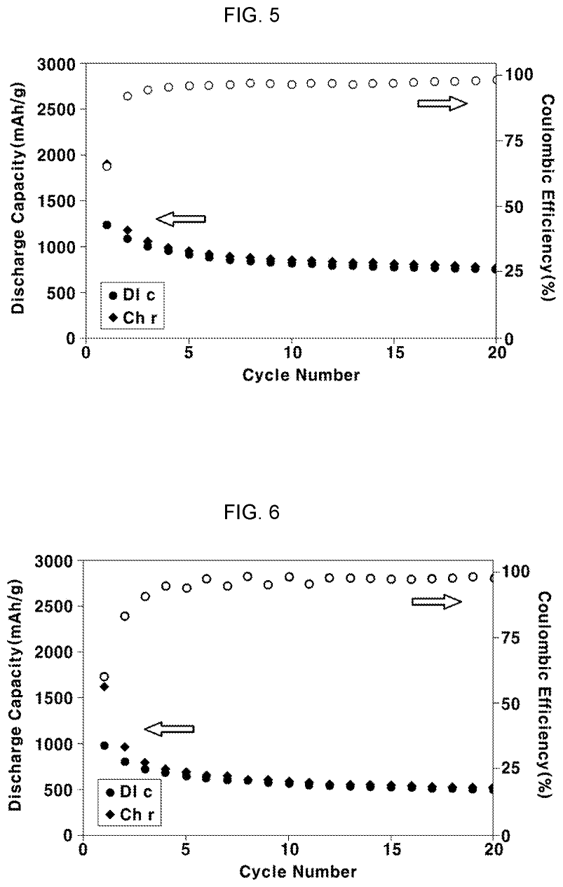

FIG. 3 shows charge/discharge capacity and coulombic efficiency of an all-solid-state battery according to Example 1. FIG. 4 shows charge/discharge capacity and coulombic efficiency of an all-solid-state battery according to Example 2. FIG. 5 shows charge/discharge capacity and coulombic efficiency of an all-solid-state battery according to Example 3. FIG. 6 shows charge/discharge capacity and coulombic efficiency of an all-solid-state battery according to Example 4.

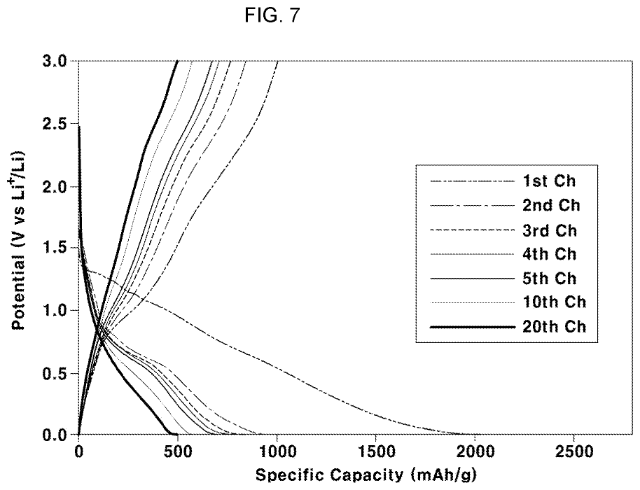

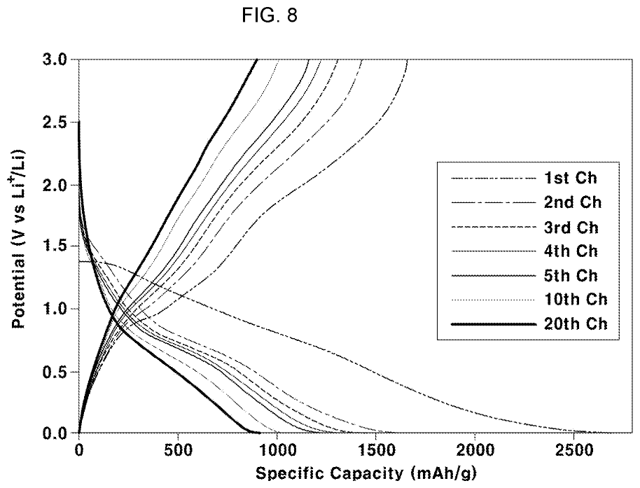

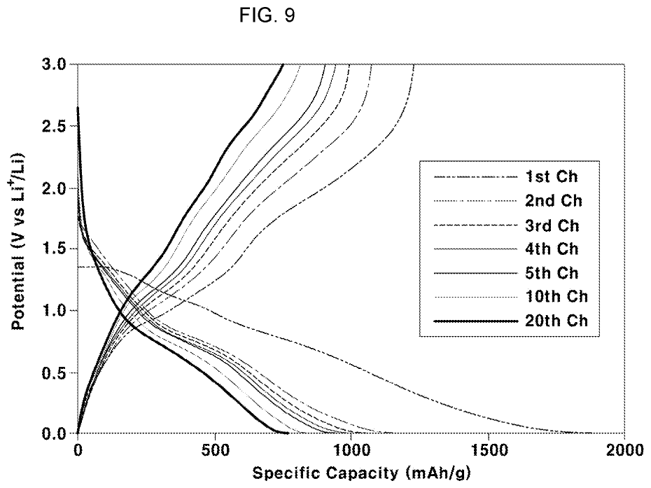

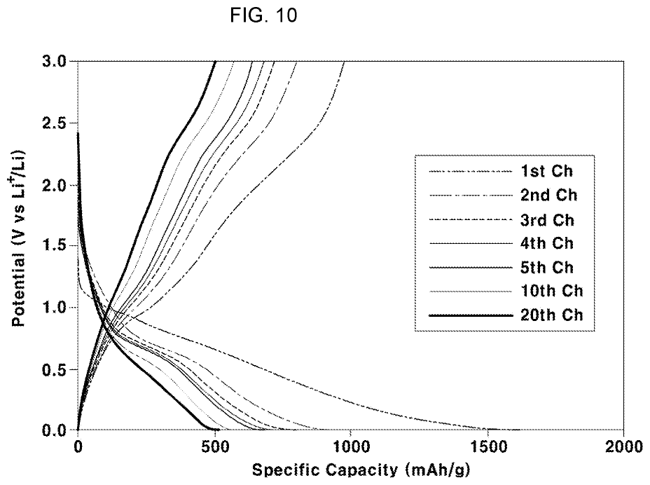

FIG. 7 shows specific capacity according to charging and discharging of the all-solid-state battery according to Example 1. FIG. 8 shows specific capacity according to charging and discharging of the all-solid-state battery according to Example 2. FIG. 9 shows specific capacity according to charging and discharging of the all-solid-state battery according to Example 3. FIG. 10 shows specific capacity according to charging and discharging of the all-solid-state battery according to Example 4.

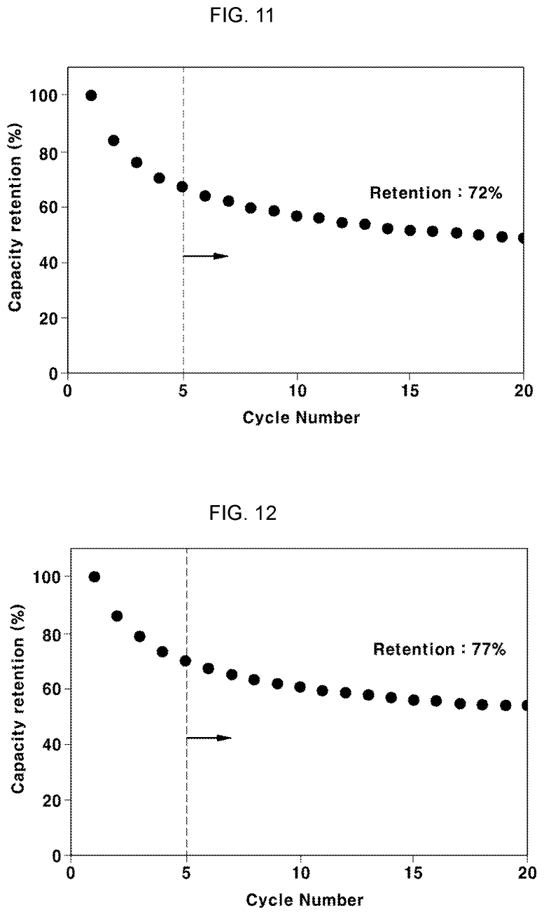

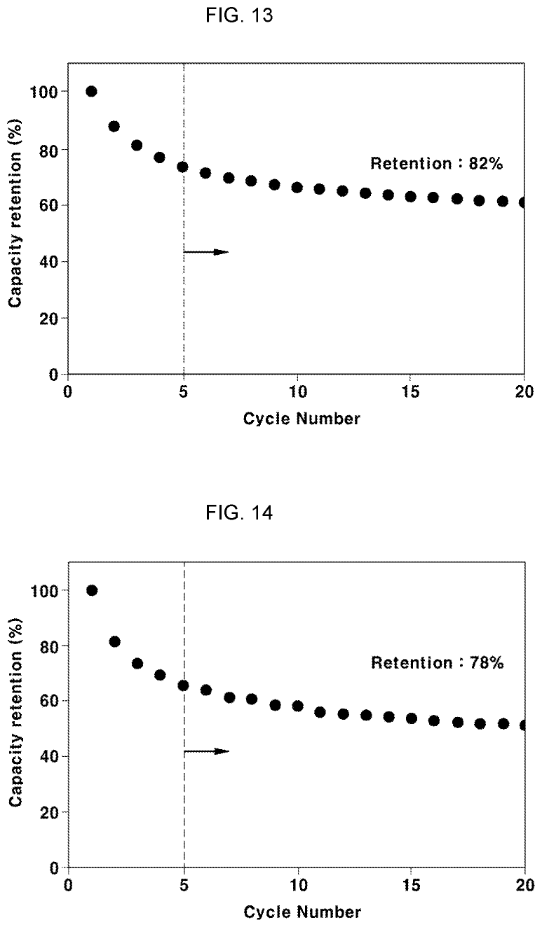

The capacity retention rate of each all-solid-state battery can be measured based on FIGS. 7 to 10. FIG. 11 shows a capacity retention rate of the all-solid-state battery according to Example 1. FIG. 12 shows a capacity retention rate of the all-solid-state battery according to Example 2. FIG. 13 shows a capacity retention rate of the all-solid-state battery according to Example 3. FIG. 14 shows a capacity retention rate of the all-solid-state battery according to Example 4. FIG. 15 shows charge/discharge capacity and coulombic efficiency of an all-solid-state battery according to Example 5. FIG. 16 shows specific capacity according to charging and discharging of the all-solid-state battery according to Example 5. FIG. 17 shows a capacity retention rate of the all-solid-state battery according to Example 5.

Table 1 below shows the electrochemical properties of the all-solid-state batteries according to Examples 1 to 5.

TABLE 1

| | Anode layer component | | | Initial | |
|---|---|---|---|---|---|
| | | Solid electrolyte | Whether there | coulombic | Capacity |
| | MOF content [% | content [% by | is a lithium | efficiency | retention rate |
| Classification | by weight] | weight] | layer or not | [%] | @20cycle [%] |
| Example 1 | 70 | 30 | x | 49 | 72 |
| Example 2 | 60 | 40 | x | 62 | 77 |
| Example 3 | 50 | 50 | x | 65 | 82 |
| Example 4 | 70 | 30 | ∘ | 60 | 78 |
| Example 5 | 45 | 55 | x | 62 | 90 |

Referring to Examples 1 to 3 and 5, it can be seen that the higher the solid electrolyte content is, the more the initial coulombic efficiency and the capacity retention rate are improved. Meanwhile, when comparing Example 1 and Example 4, it can be seen that the initial coulombic efficiency and capacity retention rate may be increased when the lithium layer is formed even if the solid electrolyte content is lowered. It is possible that initial coulombic efficient and capacity retention rate increase with less than about 45% of MOF and more than about 55% of solid electrolyte although too little amount of MOF and too high amount of solid electrolyte is not desirable.

Metal-organic frameworks (MOFs) were prepared in the same manner as in the Preparation Example by changing the metal ions and organic ligands as shown in Table 2 below.

After manufacturing half-cells in the same manner as in Example 2 using the metal-organic frameworks (MOFs), the electrochemical properties of the half-cells were evaluated. The results are shown in Table 2.

TABLE 2

| | | Plateau potential | Average capacity | Initial coulombic |
|---|---|---|---|---|
| Metal ions | Organic ligands | [V] | [mAh/g] | efficiency [%] |
| Lithium | 1,4-BDCA | 0.8 | 60 | 21 |
| | 2,6-NDCA | 0.8 | 70 | 22 |
| | EA | 0.5 | 35 | 13 |
| | 1,4,5,8-NTCA | 0.5 | 305 | 22 |
| | 3,4,9,10-PTCA | 0.8 | 600 | 39 |
| Manganese | 1,4-BDCA | 0.5 | 167 | 28 |
| | 2,6-NDCA | 0.5 | 165 | 24 |
| | BPTC | 0.5 | 240 | 20 |
| Nickel | 1,4-BDCA | 0.6 | 183 | 42 |
| | 2,6-NDCA | 0.6 | 170 | 39 |
| | BPTC | 0.6 | 250 | 23 |
| Nickel/manganese | BPTC | 0.5 | 380 | 24 |
| Cobalt | BPTC | 0.5 | 170 | 17 |
| | 1,4-BDCA | 0.5 | 400 | 42 |
| | 2,6-NDCA | 0.5 | 405 | 43 |
| | EA | 0.8 | 170 | 28 |
| | 1,4,5,8-NTCA | 0.5 | 460 | 33 |
| | 3,4,9,10-PTCA | 0.5 | 150 | 14 |
| | BPTC | 0.6 | 305 | 27 |
| | 2,5-TPDC | 0.5 | 960 | 62 |

A metal-organic framework containing lithium ions is structurally stable since it performs charging and discharging by performing intercalation and deintercalation of lithium ions. A metal-organic framework containing manganese ions shows a thin plate-like particle shape and has stable charge and discharge characteristics. A metal-organic framework containing nickel ions has an advantage in that it has high average capacity. A metal-organic framework containing nickel ions and manganese ions exhibits a low plateau potential of 0.5 V. A metal-organic framework containing cobalt ions exhibits high capacity, high Coulombic efficiency, and low plateau potential, and a metal-organic framework containing 2,5-TPDC as an organic ligand among them shows the most excellent electrochemical properties. In some embodiments, a heterocyclic organic ligand is preferred. In some embodiments, a sulfide-based solid electrolyte is preferred.

Since the Experimental Examples and Examples of the present disclosure have been described in detail above, the scope of rights of the present disclosure is not limited to the above-described Experimental Examples and Examples, and various modifications and improved forms of those skilled in the art using the basic concept of the present disclosure defined in the following claims are also included in the scope of rights of the present disclosure.

What is claimed is:

1. An all-solid-state battery comprising:
an anode layer comprising a solid electrolyte and a metal-organic framework (MOF);
a solid electrolyte layer disposed on the anode layer; and
a cathode layer disposed on the solid electrolyte layer.

2. The all-solid-state battery of claim 1, wherein the solid electrolyte comprises a sulfide-based solid electrolyte.

3. The all-solid-state battery of claim 1, wherein the solid electrolyte layer comprises a sulfide-based solid electrolyte.

4. The all-solid-state battery of claim 1, wherein the solid electrolyte is the same as a solid electrolyte of the solid electrolyte layer.

5. The all-solid-state battery of claim 1, wherein the MOF comprises:
metal ions; and
organic ligands bonded to the metal ions.

6. The all-solid-state battery of claim 5, wherein the metal ions comprise ions of at least one metal selected from the group consisting of lithium (Li), manganese (Mn), nickel (Ni), cobalt (Co), and combinations thereof.

7. The all-solid-state battery of claim 5, wherein the organic ligands are heterocyclic.

8. The all-solid-state battery of claim 5, wherein the organic ligands comprise at least one selected from the group consisting of 1,4-benzenedicarboxylic acid (1,4-BDCA), 2,6-naphthalenedicarboxylic acid (2,6-NDCA), ellagic acid (EA), 1,4,5,8-naphthalenetetracarboxylic acid (1,4,5,8-NTCA), 3,4,9,10-perylenetetracarboxylic acid (3,4,9,10-PTCA), biphenyltetracarboxylic acid (BPTC), 2,5-thiophenedicarboxylic acid (2,5-TPDC), and combinations thereof.

9. The all-solid-state battery of claim 5, wherein the organic ligands comprise 2,5-thiophenedicarboxylic (2,5-TPDC).

10. The all-solid-state battery of claim 1, wherein the anode layer comprises about 30% by weight to about 55% by weight of the solid electrolyte and about 45% by weight to about 70% by weight of the MOF.

11. The all-solid-state battery of claim 1, wherein the anode layer comprises more than about 55% by weight of the solid electrolyte and less than about 45% by weight of the MOF.

12. The all-solid-state battery of claim 1, wherein the all-solid-state battery further comprises a lithium layer interposed between the anode layer and the solid electrolyte layer.

13. The all-solid-state battery of claim 12, wherein the lithium layer comprises lithium powder.

14. The all-solid-state battery of claim 1, wherein the anode layer is disposed on an anode current collector.

15. The all-solid-state battery of claim 1, wherein a cathode current collector is disposed on the cathode layer.

16. An all-solid-state battery comprising:
an anode layer comprising a solid electrolyte and a metal-organic framework (MOF);
a lithium layer disposed on the anode layer;
a solid electrolyte layer disposed on the lithium layer; and
a cathode layer disposed on the solid electrolyte layer.

17. An all-solid-state battery comprising:
an anode layer comprising cobalt as a solid electrolyte and 2,5-thiophenedicarboxylic (2,5-TPDC) as a metal-organic framework (MOF);
a lithium layer disposed on the anode layer;
a solid electrolyte layer disposed on the lithium layer; and
a cathode layer disposed on the solid electrolyte layer.

18. A vehicle comprises a battery of claim 1.

19. A vehicle comprises a battery of claim 16.

20. A vehicle comprises a battery of claim 17.
